(19) United States
(12) Patent Application Publication
(10) Pub. No.: US 2007/0018521 A1
(43) Pub. Date: Jan. 25, 2007

(54) ELECTRIC PUMP

(75) Inventors: Motohisa Ishiguro, Anjo-shi (JP); Naoki Kamiya, Anjo-shi (JP); Tadashi Higuchi, Aichi-ken (JP)

Correspondence Address: DARBY & DARBY P.C., P. O. BOX 5257, NEW YORK, NY, 10150-5257, US

(73) Assignee: Aisin Seiki Kabushiki Kaisha, Kariya-shi (JP)

(21) Appl. No.: 11/457,180

(22) Filed: Jul. 13, 2006

(30) Foreign Application Priority Data
Jul. 25, 2005 (JP) 2005-214859

(51) Int. Cl. F04B 17/00; H02K 1/04; H02K 15/12

(52) U.S. Cl. 310/156.43; 417/423.7; 310/87; 310/86; 310/45; 310/43

(57) ABSTRACT

An electric pump includes a rotor including a magnet portion formed of a ring shaped structure and having a polar anisotropic ring magnet, and an impeller portion pressure-supplying a fluid and formed integrally with the magnet portion, and a stator rotating the rotor.

This application is based on and claims priority under 35 U.S.C. § 119 to Japanese Patent Application 2005-214859, filed on Jul. 25, 2005, the entire content of which is incorporated herein by reference.

### FIELD OF THE INVENTION

This invention relates to an electric pump. More particularly, the present invention pertains to an electric pump, which can improve performance and productivity thereof.

### BACKGROUND

A known electric pump is disclosed in JP2004-308562A. According to the disclosed electric pump, a stator, which is made by winding a coil around a core, is provided in a casing, a shaft is placed in a center of the stator, a rotor is rotatably located at an outer circumference of the stator around the shaft, an impeller is integrally rotatable with the rotor, fluid, which is fed into a pump chamber through an intake hole in accordance with a rotation of the impeller, is exhausted to an outside from an exhaust hole, the shaft is penetrating through the stator and is fixed to the stator, the rotor is rotatably supported by an end portion of the shaft, a base portion of the shaft is supported by a lower plate, and the stator is formed with a casing into a single member by means of resin molding. The whole rotor is made of a plastic magnet and the rotor and the impeller are formed into a single member.

Further, an electric pump, which is provided with a motor portion and a pumping portion is also known. The motor portion includes a rotor, to which a yoke and a magnet are fixed, and a stator, which is provided at an outer circumference of the rotor and is wound by winding wires. The pumping portion includes an impeller connected to the rotor.

However, according to the electric pump disclosed in JP2004-308562A, the rotor and the impeller are formed into a single member and the impeller is also made of the plastic magnet. Thus, the impeller portion, which basically does not require a magnet, includes a magnetic particle. Therefore, the whole weight of the electric pump may be increased. Further, because the impeller portion includes magnetic force, magnetic foreign substances in working fluid may be magnetically attracted to the impeller and pumping efficiency may occasionally be lowered.

Further, with the configuration of the later described electric pump, if an attempt for reducing a material cost is made, there is a danger of lowering the magnetic force and an output of the pump. Moreover, according to the later described electric pump, the magnet, the yoke, and the impeller are assembled to the rotor. With such configuration, a cost for assembling may be increased.

A need thus exists for an electric pump, which can improve performance and productivity thereof.

### SUMMARY OF THE INVENTION

According to an aspect of the present invention, An electric pump includes a rotor including a magnet portion formed of a ring shaped structure and having a polar anisotropic ring magnet, and an impeller portion pressure-supplying a fluid and formed integrally with the magnet portion, and a stator rotating the rotor.

### BRIEF DESCRIPTION OF THE DRAWINGS

The foregoing and additional features and characteristics of the present invention will become more apparent from the following detailed description considered with reference to the accompanying drawings, wherein:

FIG. 1 is a sectional view schematically illustrating a structure of an electric pump according to an embodiment of the present invention;

FIG. 2 is a sectional view schematically illustrating a structure of a rotor of the electric pump according to the embodiment of the present invention; and

FIG. 3 is a schematic view for explaining magnetic field flux flow of the rotor's magnet portion of an electric pump according to the embodiment of the present invention.

### DETAILED DESCRIPTION

An embodiment of the present invention will be explained hereinbelow with reference to the attached drawings.

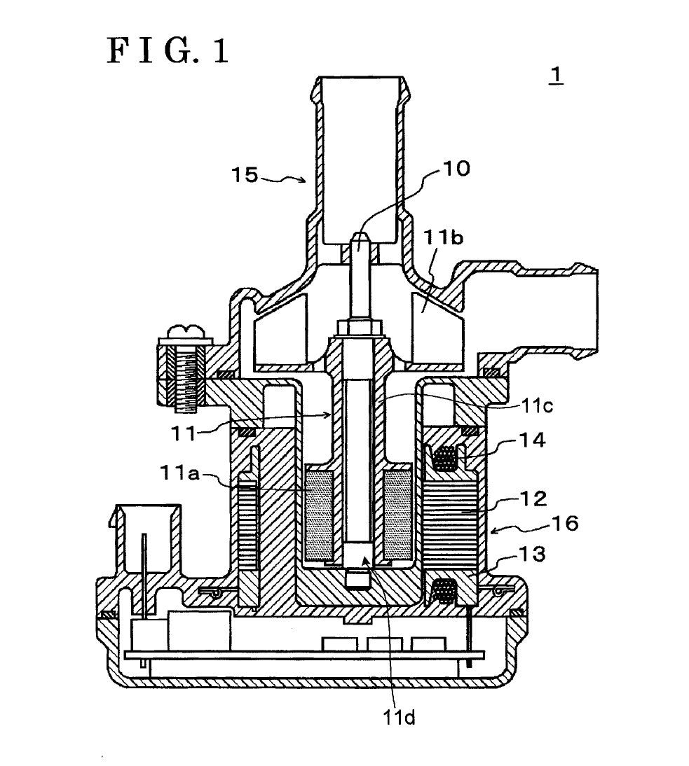

As illustrated in FIG. 1, an electric pump 1, which is electrically activated and pumps fluid, includes a shaft 10, a rotor 11, a stator 12, a dividing wall 13, winding wires 14, a pump housing 15, and a motor housing 16.

The shaft 10 is fitted together with a central axis of the rotor 11 by insertion. A first end of the shaft 10 is rotatably supported by the pump housing 15 and a second end of the shaft 10 is rotatably supported by the motor housing 16.

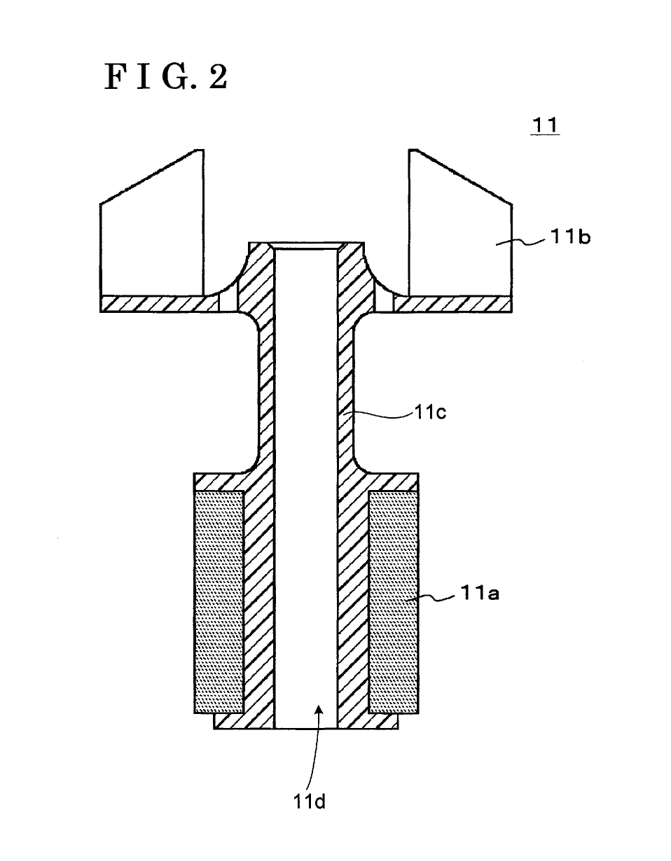

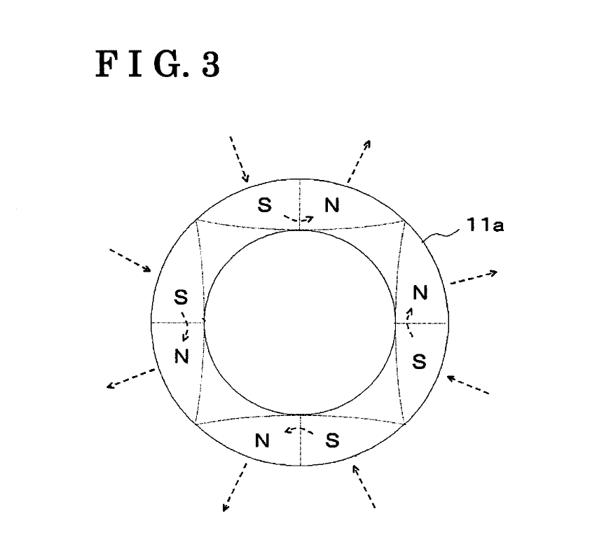

As illustrated in FIG. 2, the rotor 11 includes a magnet portion 11a, an impeller portion 11b, and a connecting portion 11c. The connecting portion 11c is formed into a substantial tubular shape which includes a hollow portion 11d. The shaft 10 is inserted through the hollow portion 11d of the connecting portion 11c and the rotor 11 is fixed to the shaft 10. The magnet portion 11a is formed at a first end of the connecting portion 11c in an axial direction and the impeller portion 11b is formed at a second end of the connecting portion 11c in the axial direction. The magnet portion 11a is formed in the vicinity of an inner circumference of the stator 12 and is rotatably housed in the motor housing 16. The magnet portion 11a is formed into a substantial annular shape (cylinder) and is made of a polar anisotropic ring magnet (i.e., a Multi-Pole Ring). For example, a polar anisotropic rare-earth bonded magnet is applicable for the magnet portion 11a. The rare-earth bonded magnet is made of high heat-resistant and low water absorption synthetic resin (binder) such as Polyphenylene Sulfide (PPS), unsaturated polyester, or the like, which includes, therein, a rare-earth magnet (magnetic particle) such as Neodymium Magnet (Nd—Fe—B), or the like. Alternatively, or in addition, any material, magnetic field flux of which is oriented as shown in FIG. 3 (polar anisotropic material), is applicable for the magnet portion 11a. The rotor 11 is integrally rotated with the shaft 10 and includes the impeller portion 11b, which propels the fluid. The impeller portion 11b is rotatably housed inside of the pump housing 15. Parts of the rotor 11 except for the magnet portion 11a, in other words, the impeller portion 11b and the connecting portion 11c, do not include the magnetic particle, and the high heat-resistant and low water absorption synthetic resin used for the resin (binder) of the magnet portion 11a such as the Polyphenylene Sulfide (PPS), the unsaturated polyester, or the like, is applicable for the impeller portion 11b and the connecting portion 11c. The rotor 11 can be formed by means of two-color injection molding. More particularly, the magnet portion 11a of the rotor 11 is formed by means of injection molding in a permanent magnet embedded die so as to form a polar anisotropic magnetic field, and then, the impeller portion 11b and the connecting portion 11c are formed by means of the injection molding. According to the embodiment of the present invention, the impeller portion 11b and the connecting portion 11c are made of resin identical to the resin used as the binder of the magnet portion 11a. Therefore, compatibility of the magnet portion 11a and the impeller portion 11b and the connecting portion 11c can be well remained, and fixation thereof can be improved by means of the two-color injection molding.

The stator 12 is provided at an outer circumference of the rotor 11 and includes protruded portions in a radiating direction. Further, the stator 12 is made of corrosion-resistant material and rotationally activates the rotor 11 by means of a rotational magnetic field generated at the stator 12. The stator 12 is formed by laminated substantial star shaped hollow thin plates, which are made by connected substantial T-shaped members in a circle. Stainless steel plate such as SUS430-CP, or the like, is applicable for material of the stator 12.

The dividing wall 13 is arranged along an outer circumference of the stator 12 and houses the stator 12 therein. The dividing wall 13 includes nonmagnetic material made of resin, or the like. An outer circumference of the dividing wall 13 is wound by the winding wires 14 in such a manner that the winding wires 14 wind around the protruded portions of the stator 12.

The winding wires 14 wind around an external side of the dividing wall 13.

A manufacturing method for the electric pump according to the embodiment of the present invention will be explained hereinafter.

First, the dividing wall 13 is arranged around the stator 12 and is integrally formed with the stator 12 by means of resin molding. Then, the dividing wall 13 is wound by the winding wires 14 from the external side thereof. Thereafter, the stator 12, the dividing wall 13, and the winding wires 14 are formed into a single member by means of the resin molding so as to form the motor housing 16.

After the rotor 11 is inserted into the motor housing 16, the motor housing 16 is fixed to the pump housing 15.

According to the embodiment of the present invention, when the winding wires 14 are applied with electricity, the magnetic field is generated from the substantial T-shaped member of the stator 12 through the rotor 11. The rotor 11 is rotated by switching current of each winding wire corresponding to each substantial T-shaped member of the stator 12.

According to the embodiment of the present invention, the polar anisotropic ring magnet is used for the magnet portion 11a of the rotor 11. Therefore, fixation of a yoke with the magnet is not required and productivity thereof can thereby be improved. Further, because the rotor 11 can be formed by means of the two-color injection (integral) molding, in other words, the magnet portion 11a of the rotor 11 and the other parts of the rotor 11, except for the magnet portion 11a, can be formed by means of the two-color injection (integral) molding, productivity thereof can be improved. According to the embodiment of the present invention, because the polar anisotropic ring magnet is used for the magnet portion 11a of the rotor 11, a magnetic pass in the magnet becomes longer therefore leading to a higher coercive force. Therefore, the electric pump according to the embodiment of the present invention is applicable for a long-term use. According to the embodiment of the present invention, the rare-earth magnet, which is superior in magnetic force, is used for the magnet portion 11a of the rotor 11. Therefore, reduction in size and weight of the electric pump and promotion of pumping efficiency can be achieved. Further, because the impeller portion 11b of the rotor 11 does not include magnetic particle, waste of magnetic particle material can be prevented and magnetic attraction of foreign substances can be prevented.

According to the embodiment of the present invention, the electric pump includes the rotor, which includes the magnet portion and the impeller portion, and the stator, which rotary activates the rotor. The magnet portion is made of the polar anisotropic ring magnet, and is formed into the substantial annular shape. The impeller portion pumps the fluid. The magnet portion and the impeller portion are formed into a single member so as to form the rotor.

The present invention is applicable when the magnet portion of the rotor is made of the resin which includes the magnetic particle therein, and the other parts of the rotor, except for the magnet portion, is made of the resin identical to the resin used for the magnet portion.

The present invention is applicable when the resin includes the Polyphenylene Sulfide and the magnetic particle includes the rare-earth magnet.

The present invention is applicable when the rotor is formed by means of the two-color injection molding. More particularly, the magnet portion of the rotor is formed by means of the injection molding in the permanent magnet embedded die so as to form the polar anisotropic magnetic field, and then, the other parts of the rotor except for the magnet portion is formed by means of the injection molding.

According to the embodiment of the present invention, the polar anisotropic ring magnet is used for the magnet portion of the rotor. Therefore, the fixation of the yoke and the magnet is not required and productivity thereof can thereby be improved. Further, because the rotor is formed by means of the two-color injection (integral) molding, in other words, the magnet portion of the rotor and the other parts of the rotor, except for the magnet portion, is formed by means of the two-color (integral) molding, productivity thereof can be improved. According to the embodiment of the present invention, because the polar anisotropic ring magnet is used for the magnet portion of the rotor, the magnetic pass in the magnet becomes longer and coercive force becomes higher. Therefore, the electric pump according to the embodiment of the present invention is applicable for a long-term use, especially under a high-temperature environment. According to the embodiment of the present invention, the rare-earth magnet, which is superior in magnetic force, is used for the magnet portion of the rotor. Therefore, reduction in size and weight of the electric pump and promotion of pumping efficiency can be achieved. Further, because the impeller portion of the rotor does not include the magnetic particle, waste of magnetic particle material can be prevented and magnetic attraction of the foreign substance can be prevented. Moreover, because the magnet portion of the rotor is made of mixed material of the resin and the magnetic particle and the other parts of the rotor, except for the magnet portion, is made of the resin identical to the resin used for the magnet portion, compatibility of the magnet portion of the rotor and the other parts of the rotor except for the magnet portion can be well remained and fixation thereof can be improved.

The principles, preferred embodiments and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An electric pump, comprising:
a rotor including:
a magnet portion formed of a polar anisotropic ring magnet; and
an impeller portion pressure-supplying a fluid and formed integrally with the magnet portion; and
a stator rotating the rotor.

2. The electric pump according to claim 1, wherein
the magnet portion of the rotor includes resin having magnetic particles and
an other part of the rotor being different from the magnet portion includes resin identical to the resin used for the magnet portion.

3. The electric pump according to claim 1, further comprising
the rotor further including a connecting portion connecting the magnet portion and the impeller portion of the rotor, the magnet portion of the rotor including resin having magnetic particles, and the connecting portion and the impeller portion of the rotor including resin identical to the resin used for the magnet portion.

4. The electric pump according to claim 2, wherein
the resin includes Polyphenylene Sulfide and
the magnetic particles include a rare-earth magnet.

5. The electric pump according to claim 3, wherein
the resin includes Polyphenylene Sulfide and
the magnetic particles include a rare-earth magnet.

6. The electric pump according to claim 1, wherein
the rotor is formed by means of a two-color injection molding in which the magnet portion of the rotor is formed by means of an injection molding in a permanent magnet embedded die for forming a polar anisotropic magnetic field, and the other part of the rotor being different from the magnet portion is formed by means of the injection molding.

7. The electric pump according to claim 2, wherein
the rotor is formed by means of a two-color injection molding in which the magnet portion of the rotor is formed by means of an injection molding in a permanent magnet embedded die for forming a polar anisotropic magnetic field, and the other part of the rotor being different from the magnet portion is formed by means of the injection molding.

8. The electric pump according to claim 3, wherein
the rotor is formed by means of a two-color injection molding in which the magnet portion of the rotor is formed by means of an injection molding in a permanent magnet embedded die for forming a polar anisotropic magnetic field, and the connecting portion and the impeller portion of the rotor are formed by means of the injection molding.

9. The electric pump according to claim 4, wherein
the rotor is formed by means of a two-color injection molding in which the magnet portion of the rotor is formed by means of an injection molding in a permanent magnet embedded die for forming a polar anisotropic magnetic field, and the other part of the rotor being different from the magnet portion is formed by means of the injection molding.

10. The electric pump according to claim 5, wherein
the rotor is formed by means of a two-color injection molding in which the magnet portion of the rotor is formed by means of an injection molding in a permanent magnet embedded die for forming a polar anisotropic magnetic field, and the connecting portion and the impeller portion of the rotor are formed by means of the injection molding.

11. The electric pump according to claim 3, wherein
the connecting portion is formed into a tubular shape having a hollow portion, the magnet portion being formed at a first end of the connecting portion in an axial direction and the impeller portion being formed at a second end of the connecting portion in the axial direction, and
the electric pump further comprises:
a pump housing rotatably housing therein the impeller portion;
a motor housing rotatably housing therein the magnet portion; and
a shaft inserted into the hollow portion, a first end of the shaft being supported by the pump housing and a second end of the shaft being supported by the motor housing.

12. The electric pump according to claim 5, wherein
the connecting portion is formed into a tubular shape having a hollow portion, the magnet portion being formed at a first end of the connecting portion in an axial direction and the impeller portion being formed at a second end of the connecting portion in the axial direction, and
the electric pump further comprises:
a pump housing rotatably housing therein the impeller portion;
a motor housing rotatably housing therein the magnet portion; and
a shaft inserted into the hollow portion, a first end of the shaft being supported by the pump housing and a second end of the shaft being supported by the motor housing.
